(19) United States
(12) Patent Application Publication
(10) Pub. No.: US 2014/0133614 A1
(43) Pub. Date: May 15, 2014

(54) Eye pattern generation of unequalized eye patterns using a serial receiver with embedded eye capability

(71) Applicants: Alexander Neal Huntley, Basingstoke (GB); Roger Fawcett, Basingstoke (GB)

(72) Inventors: Alexander Neal Huntley, Basingstoke (GB); Roger Fawcett, Basingstoke (GB)

(21) Appl. No.: 13/947,134

(22) Filed: Jul. 22, 2013

(30) Foreign Application Priority Data
Aug. 17, 2012 (GB) GB1214668.4

(51) Int. Cl. H04L 7/00

(52) U.S. Cl. CPC H04L 7/0087
USPC 375/355

(57) ABSTRACT

The use of eye pattern circuitry associated with a serial receiver embedded in an integrated circuit (e.g. in an FPGA) relies on the signal quality and signal frequency being sufficient for the serial receiver to lock onto the signal: if this is not possible then it is not possible to obtain an eye pattern.

Our novel invention enables the use of this embedded circuitry where the signal quality and signal frequency are not sufficient by splitting the incoming signal, then using the clock recovered with further processing from one of the split signals together with the built-in eye pattern circuitry to obtain a realistic eye pattern for the unprocessed signal, regardless of the quality of that unprocessed signal.

The technique uses the free-running or ‘slave’ mode of these serial receivers in which the receiver does not lock to the incoming data. To date, this mode has been used for oversampling but not for sampling at the actual data rate with a recovered clock in order obtain eye pattern samples.

### BACKGROUND OF THE INVENTION

In the field of serial data communications, the quality of a serial digital bitstream can be assessed by observing an accurate visual representation of the amplitude of the signal with respect to time. This can be performed by a traditional oscilloscope, or a dedicated electrical circuit designed specifically to look at serial bitstream signals.

When observing such a visual representation, the shape of the bitstream signal can resemble the general shape of the human eye; for this reason, the images created by circuits designed to look at serial bitstream signals are sometimes referred to as ‘Eye Patterns’.

An eye pattern displays various parameters by which the quality of a serial data signal is quantified such as: rise time, fall time, undershoot, overshoot, jitter, pulse width, amplitude, and distortion, and the variation in those parameters.

Eye patterns are often created using either a very high-speed analog-to-digital converter (ADC) or sample-and-hold integrated circuits (ICs), but now there are various ICs that incorporate serial receivers with this eye pattern ability built-in. For example, this ability may be found in:
Transceiver/Reclocker ICs
High-speed transceivers embedded in Field Programmable Gate Arrays (FPGAs)
Equaliser ICs

These circuits, however, require the signal to be of sufficient quality for the serial receiver to successfully lock onto the signal and recover the clock needed to produce eye pattern data. Using these circuits to generate an eye pattern at the receiver end of a transmission line can therefore be problematic as signals are typically degraded in transmission by cable losses. Signal-conditioning circuits can be used to improve the signal quality up to a level at which it becomes possible to produce an eye pattern but the pattern so produced shows the quality of the conditioned signal, not the raw signal quality.

Another limitation is that these serial receivers have a minimum operating frequency which can be above the data rate of some serial data streams: e.g. Standard definition SDI.

### SUMMARY OF THE INVENTION

Our invention enables an eye pattern to be generated where the signal quality or signal frequency is not sufficient for an eye capable transceiver to lock onto, by the novel idea of using the slave/free-running mode of the transceiver to sample the unadulterated signal at the actual data rate. It achieves this by splitting the incoming signal, equalising one of the split signals and recovering a clock signal from the equalized signal. In this way, our invention allows a realistic eye pattern to be obtained for the unequalized signal, regardless of the quality of that unequalized signal.

### DETAILED DESCRIPTION OF THE INVENTION

Our invention provides a way to produce an eye pattern using the eye-pattern capability of a serial receiver where the signal of interest is of insufficient quality for the serial receiver's built-in eye pattern capability. It uses a signal splitter to generate two copies of the serial data signal, one of which is conditioned as required then fed to a “master” serial receiver that locks onto the input signal and recovers a serial clock. The other copy of the signal is fed to a “slave” serial receiver with embedded eye pattern capability which is set to “free-run” i.e. it does not attempt to lock onto its serial data input. Instead, the clock generated by the master serial receiver is used to the slave serial receiver, enabling it to produce the eye pattern of the unconditioned signal.

The conditioning applied could consist of amplification, filtering or cable equalisation. The serial receivers used may be located either in the same integrated circuit or in separate ICs, depending on the data rate of the signal and the operating characteristics of the ICs.

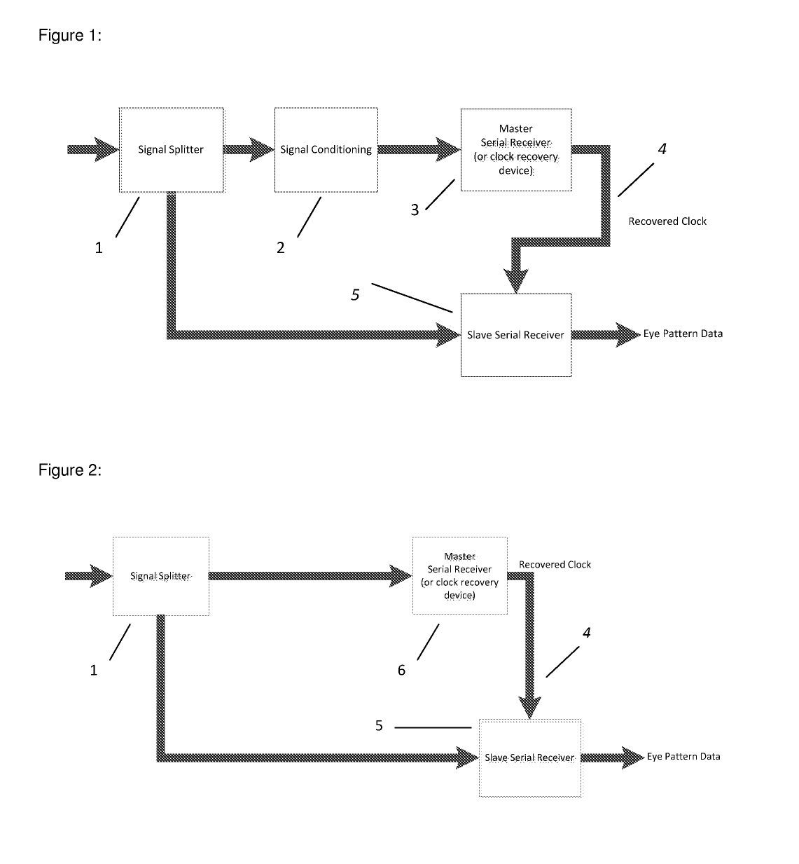

FIGS. 1, 2 and 3 illustrate three possible implementations of the invention. FIG. 1 illustrates an implementation that can be used where the data rate of the serial data signal is within the operating frequency range of the eye-capable serial receiver.

FIG. 2 illustrates the alternative style of implementation that needs to be used where the IC's minimum operating frequency is higher than the data rate of the serial data signal.

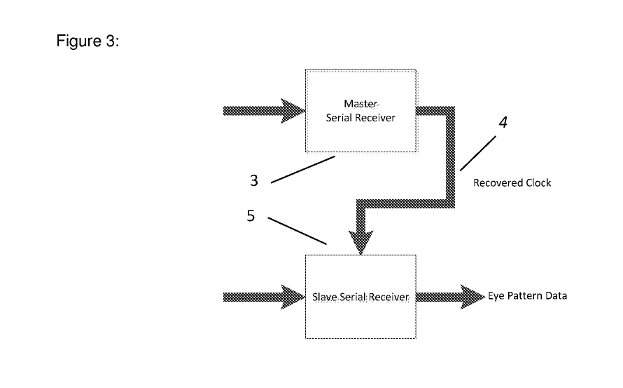

FIG. 3 illustrates how the same basic arrangement may be used to extract eye pattern data from an unrelated serial data signal.

In FIG. 1, the serial data signal is split into two identical copies by the signal splitter 1 and one copy is then conditioned by the signal conditioning unit 2 prior to being passed to the master serial receiver 3 which recovers the serial clock 4. The other copy is passed to the slave serial receiver 5. The clock signal extracted from the serial data signal by the master serial receiver 3 is used to clock the slave serial receiver 5, thereby allowing it to generate the required eye pattern.

In FIG. 2, the data signal is already of sufficient quality but its speed is below the capability of the eye-capable serial receiver 5. In these circumstances, the master serial receiver 3 in FIG. 1 by a serial receiver 6 that has the appropriate characteristics for extracting the required clock, but which may not have embedded eye capability itself. In FIG. 3, the signals to be presented to serial receivers 3 and 5 are independent. This arrangement may be used to assess the degree to which two serial data signals are synchronised.

1. Eye pattern generating apparatus comprising:
a serial data stream signal splitter which generates two or more output versions of its input serial data stream
and a signal conditioning circuit applied to the serial data stream derived from the first output of the serial data stream signal splitter to produce a conditioned signal
and a “master” serial receiver or any clock recovery device to recover a clock from the conditioned signal
and a “slave” serial receiver with integrated eye pattern capability which derives its timing reference from the clock recovered by the “master” serial receiver or clock recovery device and the “slave” serial receiver produces eye pattern data from a non-conditioned signal which is derived from the second output of the serial data stream signal splitter.

2. Eye pattern generating apparatus comprising:
a serial data stream signal splitter which generates two or more output versions of its input serial data stream
and a “master” serial receiver or any clock recovery device to recover a clock from the first output of the serial data stream signal splitter
and a “slave” serial receiver with integrated eye pattern capability which derives its timing reference from the clock recovered by the “master” serial receiver or clock recovery device and the “slave” serial receiver produces eye pattern data from the second output of the serial data stream signal splitter.

3. Eye pattern generating apparatus comprising:
a “master” serial receiver or any clock recovery device used to recover a clock from a serial data signal
and a “slave” serial receiver with integrated eye pattern capability which derives its timing reference from the clock recovered by the “master” serial receiver or clock recovery device and the “slave” serial receiver produces eye pattern data from a second serial data signal.

4. The apparatus of claim 1 where eye pattern data is taken from both the “master” serial receiver or clock recovery device and the “slave” serial receiver and a comparison made to determine the effect of the signal conditioning circuit on the quality of the signal presented to the “master” serial receiver or clock recovery device.

5. The apparatus of claim 1 where eye pattern data is taken from both the “master” serial receiver or clock recovery device and the “slave” serial receiver and a comparison made to determine the effect of the signal conditioning circuit on the delay and phase of the signal presented to the “master” serial receiver or clock recovery device.

6. The apparatus of claim 3 where eye pattern data is taken from both the “master” serial receiver or clock recovery device and the “slave” serial receiver and a comparison made to determine the similarities and differences between two serial data signals.
